(19) United States
(12) Patent Application Publication
(10) Pub. No.: US 2006/0269301 A1
(43) Pub. Date: Nov. 30, 2006

(54) Sheet conveying device, image forming apparatus and sheet conveying method

(75) Inventor: Masato Ogasawara, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/139,482

(22) Filed: May 31, 2005

(51) Int. Cl. G03G 15/00

(52) U.S. Cl. 399/21

(57) ABSTRACT

Using an operation detection switch installed in the neighborhood of a conveying path between a photosensitive drum and fixing rollers for recognizing movement of sheets of paper P from a shift of reflected light from the sheets of paper, thereby independently detecting the conveying condition of the sheets of paper, when an occurrence of jamming of the sheets of paper is detected immediately, conveying of the sheets of paper is stopped and extension of jamming is prevented.

### FIELD OF THE INVENTION

The present invention relates to a sheet conveying apparatus, an image forming apparatus and a sheet conveying method for immediately detecting the conveying condition of sheets such as paper or films and forming images on the sheets.

### DESCRIPTION OF THE BACKGROUND

Conventionally, an image forming apparatus such as a copier, a facsimile, or a printer has a single detecting means for detecting jamming of sheets of paper or sheets of film during conveying. In Japanese Patent Application Publication No. 10-218429, an apparatus for detecting an occurrence of jamming when detecting pressing of a slack sheet to a sensor lever during conveying of sheets is disclosed.

However, the conventional apparatus, before a sheet is slackened after an occurrence of jamming and presses the sensor lever, cannot detect the occurrence of jamming. Therefore, it takes a lot of time to detect jamming after an occurrence of jamming, and the jamming is extended during the period, thus sheets are shifted into the conveying path, fixing unit, or photoconductor cleaner. As a result, by the pressure of sheets, the photoconductor, fixing unit or peripheral device is spoiled or damaged, or by an unfixed toner image transferred onto a sheet, the image forming apparatus is soiled internally, thus the image quality may be lowered. Furthermore, sheets shifted into the image forming apparatus are hardly removed, thus the maintenance may require a lot of time.

Therefore, a sheet conveying device, an image forming apparatus, and a sheet conveying method for immediately detecting an occurrence of jamming during conveying of sheets, preventing extension of jamming, keeping the image forming apparatus free of damage, and ensuring superior maintainability are desired.

### SUMMARY OF THE INVENTION

Accordingly, an advantage of the present invention is to provide a sheet conveying device, an image forming apparatus, and a sheet conveying method for immediately detecting an occurrence of jamming during conveying of sheets and preventing extension of jamming.

To achieve the above advantage, one aspect of the present invention is to provide a sheet conveying device including a supply unit for supplying sheets in a predetermined direction, a conveying member for conveying the sheets supplied by the supply unit in the predetermined direction on the conveying path, a loading unit for loading the sheets conveyed by the conveying member, an operation detection member arranged in the neighborhood of the conveying path from the supply unit to the loading unit for independently detecting the operation of the sheets on the conveying path, and a controller for controlling conveyance of the sheets according to the detection result by the operation detection member.

### BRIEF DESCRIPTION OF THE DRAWINGS

FIG. 1 is a schematic block diagram showing a part of the copier of the first embodiment of the present invention;

FIG. 2 is a schematic block diagram showing the operation detection switch of the first embodiment of the present invention;

FIG. 3 is a block diagram showing the control system of the copier of the first embodiment of the present invention;

FIG. 4 is a flow chart showing the conveying condition detection process of sheets of paper P of the first embodiment of the present invention;

FIG. 5 is a schematic block diagram showing the operation detection switch of the second embodiment of the present invention;

FIG. 6 is a flow chart showing the conveying condition detection process of sheets of paper P of the second embodiment of the present invention;

FIG. 7 is a schematic block diagram showing a part of the copier of the third embodiment of the present invention;

FIG. 8 is a schematic block diagram showing a part of the copier of the fourth embodiment of the present invention;

FIG. 9 is a schematic block diagram showing a part of the copier of the fifth embodiment of the present invention having an optional function; and

FIG. 10 is a block diagram showing the control system of the copier of the fifth embodiment of the present invention having an optional function.

### DETAILED DESCRIPTION OF THE INVENTION

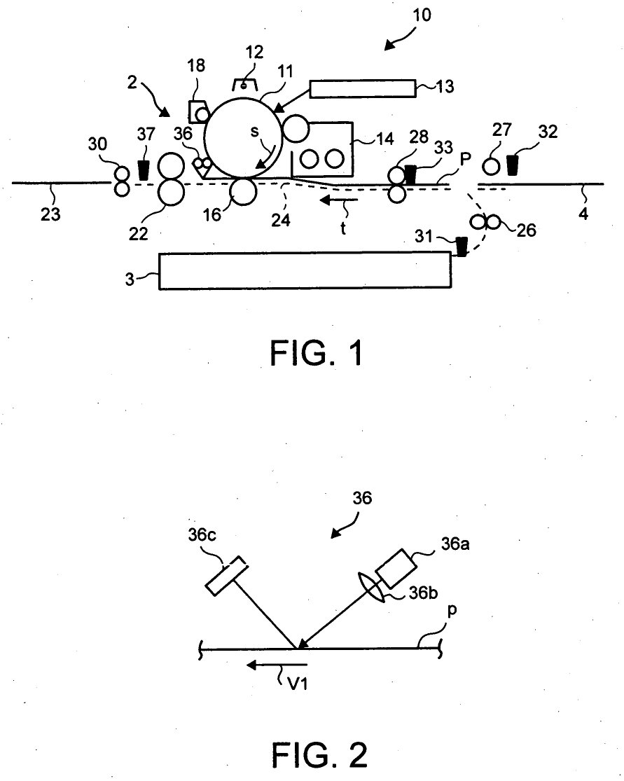

Hereinafter, the first embodiment of the present invention will be explained in detail with reference to the accompanying drawings. FIG. 1 is a schematic block diagram showing a part of copier 10 which is an image forming apparatus using the sheet conveying apparatus of the embodiments of the present invention. Copier 10 has paper supply cassette 3 which is a supply unit for storing sheets of paper P which are sheets supplied toward image forming unit 2. Further, copier 10 has paper supply tray 4 which is a supply unit for manually supplying sheets of paper P toward image forming unit 2.

Image forming unit 2, around photosensitive drum 11 which is an image carrying member, has main charger 12 for uniformly charging photosensitive drum 11 according to the rotation of photosensitive drum 11 in the direction of arrow s, exposure device 13 for forming a latent image on charged photosensitive drum 11, developing apparatus 14, transfer roller 16 which is a transfer unit, and cleaner unit 18.

On the downstream side of image forming unit 2 in the conveying direction of sheets of paper P, fixing rollers 22 which are a fixing unit for clamping and conveying sheets of paper P and heating, pressurizing, and fixing a toner image are installed. On the downstream side of fixing rollers 22, paper ejection tray 23 which is a loading unit for loading fixed sheets of paper P is installed.

Between paper supply cassette 3 or paper supply tray 4 and paper ejection tray 23 via transfer roller 16, conveying path 24 for conveying sheets of paper P in the direction of arrow t which is a predetermined direction is arranged. On conveying path 24, conveying rollers 26 which are a conveying member for conveying sheets of paper P supplied from paper supply cassette 3 and a manual conveying roller 27 which is a conveying member for conveying sheets of paper P supplied from paper supply tray 4 are installed. Further, on conveying path 24, aligning rollers 28 which are a conveying member for stopping once sheets of paper P conveyed from conveying rollers 26 or manual conveying roller 27 and conveying them toward photosensitive drum 11 are installed. Further, on conveying path 24, paper ejection rollers 30 for conveying sheets of paper P passing fixing rollers 22 toward paper ejection tray 23 are installed.

Furthermore, to detect sheets of paper P conveyed on conveying path 24, in the neighborhood of conveying path 24 from paper supply cassette 3 or paper supply tray 4 to photosensitive drum 11, first to third passing detection switches 31, 32 and 33 which are passing detection members are arranged. Further, in the neighborhood of conveying path 24 from photosensitive drum 11 to fixing rollers 22, operation detection switch 36 which is an operation detection member is arranged. In the neighborhood of conveying path 24 from fixing rollers 22 to paper ejection tray 23, fourth passing detection switch 37 which is a passing detection member is arranged.

Passing detection switches 31, 32, 33 and 37 detect whether sheets of paper P exist at the positions of passing detection switches 31, 32, 33 and 37 or not. Namely, passing detection switches 31, 32, 33 and 37 turn on when sheets of paper P reach and turn off when sheets of paper P pass. The detection mechanism of passing detection switches 31, 32, 33 and 37 is optional such as a mechanical switch for detecting the lever operation or an optical switch for detecting transmitted light or reflected light.

Operation detection switch 36 detects the operation of sheets of paper P, that is, the conveying condition. Operation detection switch 36 is of an optical type and as shown in FIG. 2, has light emission unit 36a such as a light emission diode (LED), lens & prism 36b and light reception unit 36c. In operation detection switch 36, light is emitted from light emission unit 36a and reaches sheet of paper P via lens & prism 36b, and a part of light diffused by sheet of paper P is recognized as a pattern by light reception unit 36c.

Light reception unit 36c photographs reflected light as an image, continues photographing of images, thereby recognizes the movement of sheet of paper P from a shift between the preceding and succeeding images. When sheet of paper P is stopped or there is no sheet of paper P, no image shift occurs, so that the light received image of the light reception unit 36c is not shifted. When sheet of paper P moves, the preceding and succeeding images are shifted, so that the light received image of light reception unit 36c is shifted in the pattern.

When sheets of paper P are conveyed at a fixed speed and the speed is not changed, shifts of the pattern recognized by light reception unit 36c are fixed. Assuming that a specific pattern moves by a distance of ΔL (mm) for a time of Δt (s), as a conveying speed of V1 of sheets of paper P, V1=ΔL/Δt (mm/s) can be obtained. When Δt is set to a small value, the movement of sheets of paper P can be detected more immediately. When sheets of paper P are jammed and the speed of sheets of paper P is changed, the shift amount of the pattern recognized by light reception unit 36c is changed. At this time, conveying speed V1 (mm/s) of sheets of paper P changes for each time and when conveying speed V1 (mm/s) is compared for each time, acceleration A1 (mm/s²) can be calculated. Operation detection switch 36 obtains the conveying condition of sheets of paper P from the speed or acceleration of sheets of paper P on conveying path 24.

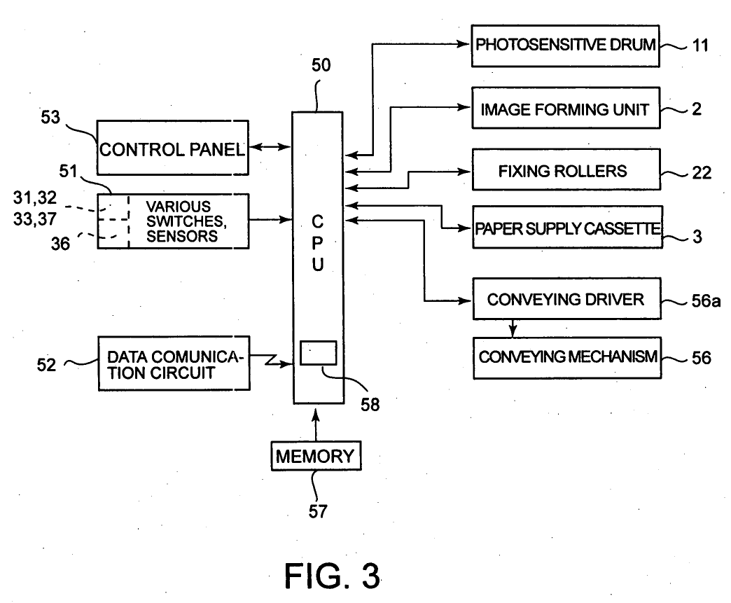

Next, the control system of copier 10 will be explained by referring to the block diagram shown in FIG. 3. To the input side of CPU 50 for controlling whole copier 10, various switches and sensors 51 including first to fourth passing detection switches 31, 32, 33 and 37 and operation detection switch 36 are connected. CPU 50 is a controller for controlling conveyance of sheets of paper P according to detection results from first to fourth passing detection switches 31, 32, 33 and 37 or operation detection switch 36. Further, to the input side of CPU 50, data communication circuit 52 for transmitting image information from a computer terminal is connected. Furthermore, to CPU 50, operation panel 53 for inputting image forming conditions such as the copy mode, selection of sheets of paper, and the number of sheets, photosensitive drum 11, image forming unit 2, fixing rollers 22 and paper supply cassette 3 are connected and conveying mechanism 56 of sheets of paper P is also connected via conveying driver 56a.

CPU 50 has memory 57 for storing reference conveying speed V0 (mm/s) of sheets or reference acceleration A0 (mm/s²) as a reference value. Furthermore, CPU 50 has arithmetic unit 58 for comparing the detection results from first to fourth passing detection switches 31, 32, 33 and 37 or operation detection switch 36 with the speed or acceleration stored in memory 51. CPU 50 has conveying driver 56a for driving conveying mechanism 56a for conveying sheets of paper P, calculating jamming of sheets of paper P on conveying path 24 from the calculation results by arithmetic unit 58, thereby stopping conveyance of sheets of paper P.

Next, the operation of the invention will be described. At the start of the image forming process, a user sets various image forming conditions by operation panel 53. At the time of setting the image forming conditions, when supplying sheets of paper P from paper supply cassette 3, paper supply cassette 3 is selected and when supplying sheets of paper P from paper supply tray 4, sheets of paper P are set on paper supply tray 4. When the image forming process is started, in image forming means 2, photosensitive drum 11 is uniformly charged by main charger 12 according to rotation in the direction of arrow s and then is irradiated with a laser beam according to a document image by exposure device 13, thus an electrostatic latent image is formed. Then, the electrostatic latent image is developed by developing apparatus 14 and a toner image is formed on photosensitive drum 11.

In synchronization with forming of the toner image, a predetermined sheet of paper P is supplied from paper supply cassette 3 or paper supply tray 4 and is conveyed toward photosensitive drum 11. Sheet of paper P conveyed by conveying rollers 26 or manual conveying roller 27 is stopped once by aligning rollers 28 and is conveyed again toward photosensitive drum 11 in synchronization with the toner image formed on photosensitive drum 11. Sheet of paper P, when reaching photosensitive drum 11, is transferred with the toner image on photosensitive drum 11 by transfer roller 16. Hereafter, while sheet of paper P is clamped and conveyed by fixing rollers 22, the toner image is heated, pressurized, and fixed, thus sheet of paper P is conveyed by paper ejection rollers 30 and is loaded on paper ejection tray 23. Photosensitive drum 11 after end of transfer is cleaned residual toner by cleaner unit 18 and waits for the next image forming process.

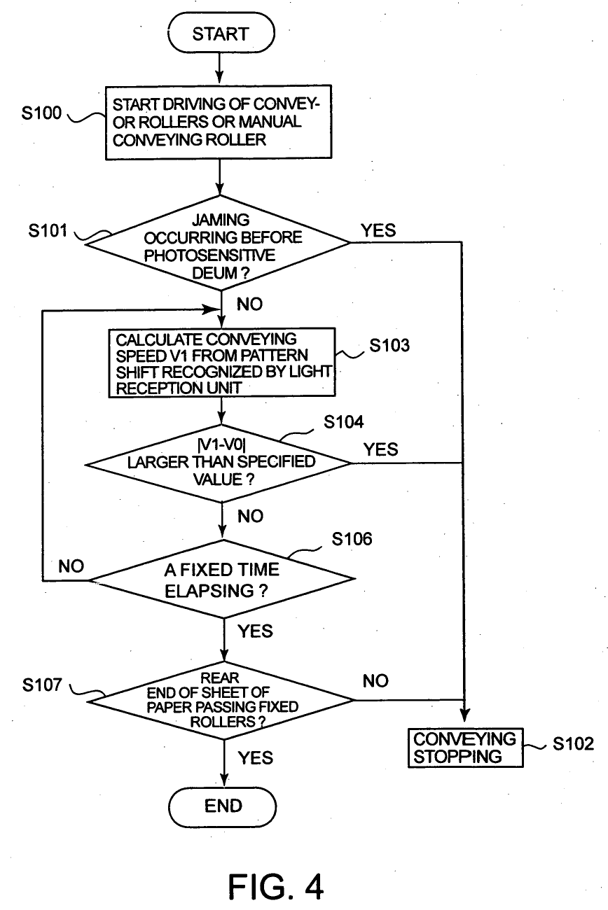

Next, the conveying condition detection process of sheets of paper P by operation detection switch 36 during execution of the image forming process will be explained by referring to the flow chart shown in FIG. 4. When the image forming process is started, to start conveyance of sheets of paper P supplied from paper supply cassette 3 or paper supply tray 4 at Step 100, conveying rollers 26 or manual conveying roller 27 is driven to start.

At Step 101, jamming of sheets of paper P between paper supply cassette 3 or paper supply tray 4 and photosensitive drum 11 is detected by first to third passing detection switches 31 to 33. Namely, when third passing detection switch 33 is not turned on even if a predetermined time elapses after first or second passing detection switch 31 or 32 is turned on, CPU 50 goes to Step 102. At Step 102, CPU 50 judges that between paper supply cassette 3 or paper supply tray 4 and aligning rollers 28, jamming of sheets of paper P occurs and controls to stop conveying mechanism 56 of sheets of paper P. Further, when operation detection switch 36 does not detect the movement of sheets of paper P even if a predetermined time elapses after third passing detection switch 33 is turned on, at Step 102, CPU 50 judges jamming of sheets of paper P before they reach photosensitive drum 11 and controls to stop conveying mechanism 56.

However, at Step 101, two switches among first to third passing detection switches 31 to 33 and operation detection switch 36 are used to detect jamming of sheets of paper P, so that when jamming occurs, before detection of jamming, a predetermined time is required. Therefore, until CPU 50 stops conveying mechanism 56 at Step 102, conveyance of sheets of paper P is continued. Stop control of conveying mechanism 56 is displayed on operation panel 53, so that the operator removes the jam at the place displayed on operation panel 53 and restarts the image forming process.

When no jamming is detected at Step 101, CPU 50 goes to Step 103. At Step 103, from the pattern shift of the reflected light from sheet of paper P during conveying which is recognized by light reception unit 36c of operation detection switch 36, conveying speed V1 (mm/s) of sheet of paper P is calculated by arithmetic unit 58 of CPU 50. Then, CPU 50 goes to Step 104 and compares calculated conveying speed V1 (mm/s) with reference conveying speed V0 (mm/s) stored in memory 57. As a result, difference |V1−V0| between conveying speed V1 (mm/s) obtained from the pattern shift recognized by light reception unit 36c and reference conveying speed V0 (mm/s) is calculated by arithmetic unit 58 and when a calculation result that |V1−V0| is larger than the specified value is obtained, CPU 50 goes to Step 102. At Step 102, CPU 50 judges jamming of sheets of paper P and controls to stop conveying mechanism 56 of sheets of paper P.

At Step 104, operation detection switch 36 can independently detect jamming of sheets of paper P, so that when jamming occurs and the speed of sheets of paper P is changed, jamming can be detected immediately. Therefore, even if jamming occurs, before sheets of paper P are bent between photosensitive drum 11 and fixing rollers 22 or are bent before paper ejection rollers 30, sheets of paper P are stopped conveying immediately. Stop control of conveying mechanism 56 is displayed on operation panel 53, so that the operator removes the jam at the place displayed on operation panel 53 and restarts the image forming process.

Further, at Step 104, for example, when a passing detection switch for detecting existence of sheets of paper P is arranged at the position of operation detection switch 36 and jamming is detected from the passing condition between two points such as the concerned position and third passing detection switch 33 on the upstream side, detection of jamming is delayed. The reason is that when sheets of paper P are long, the time required for sheets of paper P from arrival at the passing detection switch to passing it is long, so that between the timing of the passing detection switch on the upstream side to turn on and the timing of the passing detection switch on the downstream side to turn on, jamming cannot be detected. On the other hand, in this embodiment, at Step 104, operation detection switch 36 detects independently the conveying condition of sheets of paper P and detects jamming, so that even when sheets of paper P are long and do not pass third passing detection switch 33 on the upstream side, jamming can be detected immediately.

Further, at Step 104, from conveying speed V1 (mm/s) of sheets of paper P obtained from the pattern shift recognized by light reception unit 36c, acceleration A1 (mm/s²) is calculated and depending on whether difference |A1−A0| from reference acceleration A0 (mm/s²) stored in memory 57 is within the range of the specified value or not, jamming of sheets of paper may be detected.

Detection of jamming at Step 104 is continued until sheets of paper P pass operation detection switch 36 and when a predetermined time elapses at Step 106, CPU 50 goes to Step 107. At Step 107, CPU 50 checks by fourth passing detection switch 37 whether the rear end of sheet of paper P passes fixing rollers 22 within a predetermined time. When it is detected at Step 107 that sheets of paper P pass fixing rollers 22 within the predetermined time, the conveying process of sheets of paper P of the image forming process is finished. When it is not detected at Step 107 that sheets of paper P pass fixing rollers 22 within the predetermined time, CPU 50 goes to Step 102, detects jamming of sheets of paper P, and controls to stop conveying mechanism 56 of sheets of paper P. Further, when CPU 50 controls to stop conveying mechanism 56 of sheets of paper P in the conveying condition process of sheets of paper P, the image forming process, according to the stage of the process, controls to stop each image forming process.

In this embodiment having such a constitution, in the neighborhood of conveying path 24 from photosensitive drum 11 to fixing rollers 22, operation detection switch 36 is arranged, and light reception unit 36c recognizes the movement of sheets of paper P from the pattern shift of reflected light from sheets of paper P, thus operation detection switch 36 independently detects the conveying condition of sheets of paper P. By doing this, operation detection switch 36 detects immediately an occurrence of jamming of sheets of paper P and can stop conveying of sheets of paper P. Therefore, it is possible to prevent slackened sheets of paper P from shifting into the circumferences of photosensitive drum 11 and fixing rollers 22 due to delay of conveying stop of sheets of paper P, or sheets of paper P from being corniced and damaging photosensitive drum 11, fixing rollers 22, and the circumferences thereof, or unfixed toner from scattering and soiling. In its turn, the image quality is prevented from lowering due to damage to photosensitive drum 11 and sheets of paper P are prevented from soiling due to soiling of fixing rollers 22. Further, removal maintenance of sheets of paper P is facilitated. Further, operation detection switch 36 is kept in non-contact with sheets of paper P, so that it can be arranged in an optional space in the neighborhood of conveying path 24 from photosensitive drum 11 to fixing rollers 22 and the degree of freedom of design is obtained.

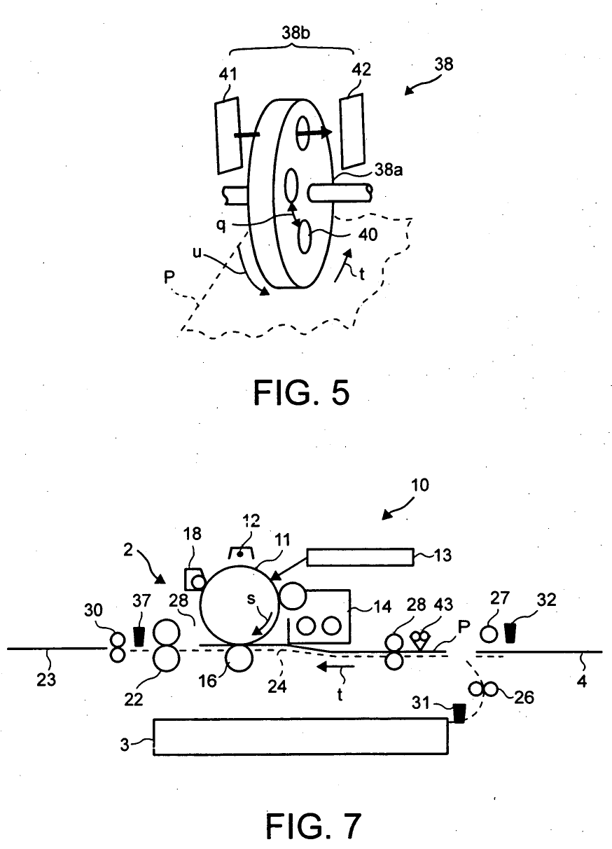

Next, the second embodiment of the present invention will be explained. In the second embodiment, the constitution of the operation detection switch which is an operation detection member is different from that in the first embodiment. Therefore, in the second embodiment, to the parts having the same constitution as that explained in the first embodiment, the same numerals are assigned and the detailed explanation thereof will be omitted. As shown in FIG. 5, operation detection switch 38 of this embodiment has a mechanism of a combination of the optical system and mechanical system. Operation detection switch 38 has disk 38a which is a rotary member which makes contact with sheets of paper P traveling between photosensitive drum 11 and fixing roller 22 and follows traveling of sheets of paper P. In disk 38a, a plurality of holes 40 are made. Furthermore, operation detection switch 38 has disk detection switches 38b which are follower detection members composed of light emission element 41 and light reception element 42 respectively arranged on both sides of disk 38a. When light from light emission element 41 of operation detection switch 38 is irradiated to disk 38a rotating by following sheets of paper P, light reception element 42 recognizes the receiving cycle of light passing holes 40 of disk 38a and detects the operation of sheets of paper P.

When sheets of paper P are conveyed at a fixed speed and the speed is not changed, the light reception cycle recognized by light reception element 42 is fixed. Assuming the detection cycle of passing light by light reception element 42 as ΔT (s) and the pitch of holes 40 as Δq (mm), conveying speed V2 (mm/s) of sheets of paper P is equal to Δq/ΔT (mm/s). When holes 40 are formed at a small pitch, the movement of sheets of paper P can be detected more immediately. When sheets of paper P are jammed and the speed of sheets of paper P is changed, the light reception cycle detected by light reception element 42 is changed. At this time, conveying speed V2 (mm/s) of sheets of paper is changed for each time, so that when conveying speed V2 (mm/s) is compared for each time, acceleration A2 (mm/s²) can be calculated.

In the image forming process, during passing of sheets of paper P through conveying path 24, in operation detection switch 38, when sheets of paper P conveyed in the direction of arrow t pass the position of photosensitive drum 11 and then reach the position of operation detection switch 38, disk 38a is driven to rotate in the direction of arrow u. Disk detection switch 38b recognizes the cycle of light received by light reception element 41 while disk 38a is driven to rotate and detects jamming of sheets of paper P.

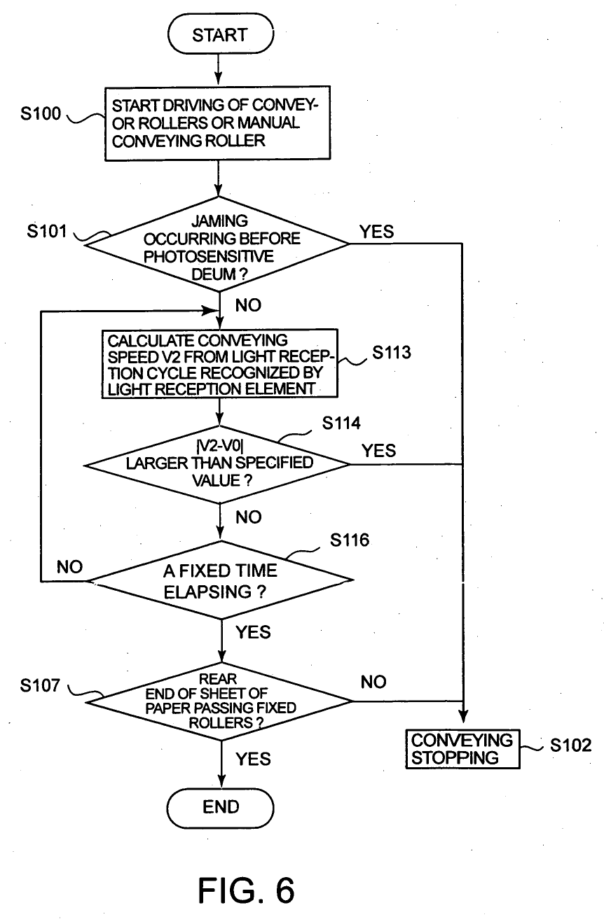

As shown in the flow chart in FIG. 6, when no jamming is detected at Step 101, CPU 50 goes to Step 113. At Step 113, from the light reception cycle recognized by light reception element 42 of operation detection switch 38, conveying speed V2 (mm/s) of sheet of paper P is calculated by arithmetic unit 58 of CPU 50. Then, CPU 50 goes to Step 114 and compares calculated conveying speed V2 (mm/s) with reference conveying speed V0 (mm/s) stored in memory 57. As a result, difference |V2−V0| between conveying speed V2 (mm/s) obtained from the light reception cycle recognized by light reception element 42 and reference conveying speed V0 (mm/s) is calculated by arithmetic unit 58 of CPU 50 and when a calculation result that |V2−V0| is larger than the specified value is obtained, CPU 50 goes to Step 102. At Step 102, CPU 50 judges jamming of sheets of paper P and controls to stop conveying mechanism 56 of sheets of paper P.

At Step 114, operation detection switch 38 can independently detect jamming of sheets of paper P, so that when jamming occurs and the speed of sheets of paper P is changed, jamming can be detected immediately. Therefore, CPU 50 immediately controls to stop conveying mechanism 56 and immediately stops conveying of sheets of paper P. Stop control of conveying mechanism 56 is displayed on operation panel 53, so that the operator removes the jam at the place displayed on operation panel 53 and restarts the image forming process.

Further, at Step 114, from conveying speed V2 (mm/s) of sheets of paper P obtained from the light reception cycle recognized by light reception element 42, acceleration A2 (mm/s²) is calculated and depending on whether difference |A2−A0 | from reference acceleration A0 (mm/s²) stored in memory 57 is within the range of the specified value or not, jamming of sheets of paper may be detected. Detection of jamming at Step 114 is continued until sheets of paper P pass operation detection switch 38 and when a predetermined time elapses at Step 116, CPU 50 goes to Step 117.

In this embodiment having such a constitution, in the neighborhood of conveying path 24 from photosensitive drum 11 to fixing rollers 22, operation detection switch 38 is arranged, and light reception element 42 recognizes the reception cycle of light passing the holes of disk 38a, thus operation detection switch 38 independently detects the conveying condition of sheets of paper P. By doing this, operation detection switch 38 detects immediately an occurrence of jamming of sheets of paper P and can stop conveying of sheets of paper P. Therefore, stopping of conveyance of sheets of paper P is not delayed, and photosensitive drum 11, fixing rollers 22, and the circumferences thereof can be prevented from soiling, and removal maintenance of sheets of paper P is facilitated.

Next, the third embodiment of the present invention will be explained. In the third embodiment, the arrangement position of the operation detection switch which is an operation detection member is different from that in the first embodiment. In this embodiment, the second passing detection switch of the first embodiment is changed to an operation detection switch. Therefore, in the this embodiment, to the parts having the same constitution as that explained in the first embodiment, the same numerals are assigned and the detailed explanation thereof will be omitted.

In this embodiment, as shown in FIG. 7, in the neighborhood of conveying path 24 from photosensitive drum 11 to fixing rollers 22, the detection means of sheets of paper P is not arranged and on the upstream side of aligning rollers 28, in the neighborhood of conveying path 24, operation detection switch 43 which is an operation detection member is arranged. Operation detection switch 43 has the same structure as that of operation detection switch 36 of the first embodiment. Operation detection switch 43 recognizes the movement of sheets of paper P passing the upstream side of aligning rollers 28 on conveying path 24 and calculates the conveying speed or acceleration of sheets of paper P by arithmetic unit 58 of CPU 50. Operation detection switch 43 compares the calculated conveying speed or acceleration with reference conveying speed V0 or reference acceleration of memory 57 and detects an occurrence of jamming of sheets of paper during conveying. Further, when detecting an occurrence of jamming, CPU 50 controls to stop conveying mechanism 56 of sheets of paper P.

Further, operation detection switch 43 can immediately detect an occurrence of jamming on the upstream side of aligning rollers 28 and can stop the image forming process. Therefore, although no sheets of paper P reach the position of photosensitive drum 11, a toner image formed on photosensitive drum 11 is not transferred and transfer roller 16 and the peripheral devices thereof are not soiled by adhesion of toner.

In this embodiment having such a constitution, operation detection switch 43 arranged on the upstream side of aligning rollers 28 independently recognizes the conveying condition of sheets of paper P, detects immediately an occurrence of jamming of sheets of paper P, and can stop conveying of sheets of paper P. Therefore, similarly to the first embodiment, the peripheral devices of the occurred jam can be prevented from soiling due to delay of conveyance stop of sheets of paper P. Further, removal maintenance of sheets of paper P is facilitated.

Next, the fourth embodiment of the present invention will be explained. In the fourth embodiment, the arrangement position of the operation detection switch which is an operation detection member is different from that in the first embodiment. In this embodiment, the operation detection switch of the first embodiment is arranged between the aligning rollers and the photosensitive drum instead of between the photosensitive drum and the fixing rollers. Therefore, in the this embodiment, to the parts having the same constitution as that explained in the first embodiment, the same numerals are assigned and the detailed explanation thereof will be omitted.

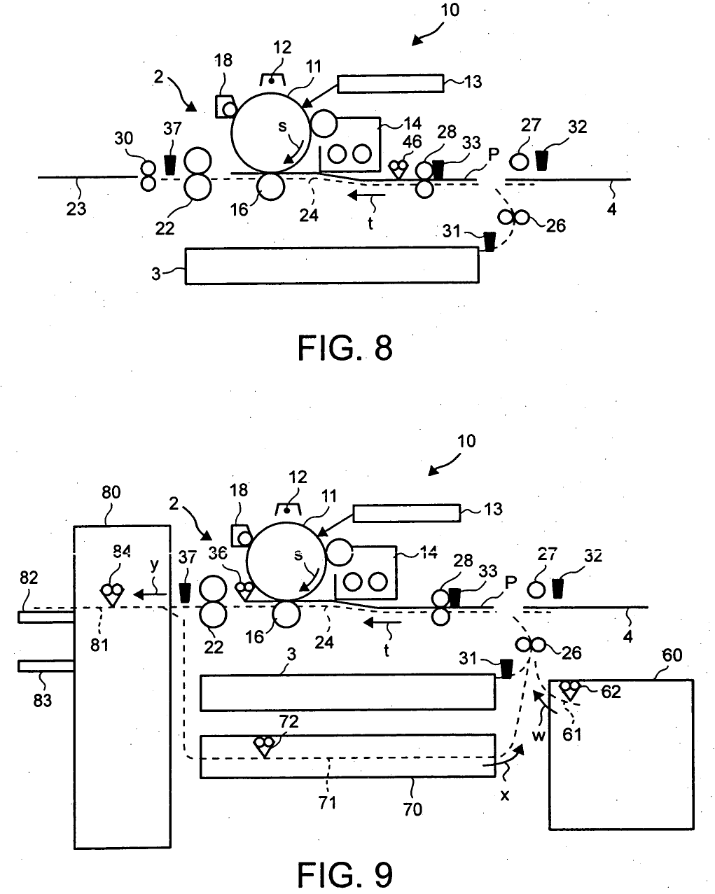

In this embodiment, as shown in FIG. 8, in the neighborhood of conveying path 24 from aligning rollers 28 to photosensitive drum 11, operation detection switch 46 which is an operation detection member is arranged. Operation detection switch 46 has the same structure as that of operation detection switch 36 of the first embodiment. Operation detection switch 46 is arranged between aligning rollers 28 and photosensitive drum 11 on conveying path 24, recognizes the movement of sheets of paper P passing here, and calculates the conveying speed or acceleration of sheets of paper P by arithmetic unit 58 of CPU 50. Operation detection switch 46 compares the calculated conveying speed or acceleration with reference conveying speed V0 or reference acceleration of memory 57 and detects an occurrence of jamming of sheets of paper during conveying. Further, when detecting an occurrence of jamming, CPU 50 controls to stop conveying mechanism 56 of sheets of paper P.

Further, operation detection switch 46 can immediately detect an occurrence of jamming between aligning rollers 28 and photosensitive drum 11 and can stop the image forming process. Therefore, although jamming occurs on the upstream side of photosensitive drum 11, it can be prevented to continue conveying of sheets of paper P, deform sheets of paper P into a cornice shape, and damage photosensitive drum 11.

In this embodiment having such a constitution, operation detection switch 46 arranged between aligning rollers 28 and photosensitive drum 11 independently recognizes the conveying condition of sheets of paper P, detects immediately an occurrence of jamming of sheets of paper P, and can stop conveying of sheets of paper P. Therefore, similarly to the first embodiment, the peripheral devices of the occurred jam can be prevented from soiling due to delay of conveyance stop of sheets of paper P. Further, removal maintenance of sheets of paper P is facilitated.

Next, the fifth embodiment of the present invention will be explained. In the fifth embodiment, the image forming apparatus in the first embodiment is provided with an optional function. Therefore, in the this embodiment, to the parts having the same constitution as that explained in the first embodiment, the same numerals are assigned and the detailed explanation thereof will be omitted.

In this embodiment, as shown in FIG. 9, copier 10, as optional functions, has large capacity paper supply device 60, double-side device 70 and finisher 80. Large capacity paper supply device 60 has paper supply conveying path 61 which is a first optional conveying path toward aligning rollers 28 in the direction of arrow w. In the neighborhood of paper supply conveying path 61, first optional operation detection switch 62 which is an operation detection member for detecting the operation of sheets of paper P is arranged. Double-side device 70 has double-side conveying path 71 which is a first optional conveying path toward aligning rollers 28 in the direction of arrow x. In the neighborhood of double-side conveying path 71, second optional operation detection switch 72 which is an operation detection member for detecting the operation of sheets of paper P is arranged. Finisher 80 has finish conveying path 81 which is a second optional conveying path in the direction of arrow y for finishing sheets of paper P after end of fixing by fixing rollers 22 and loading them on finish trays 82 and 83 which are loading units. In the neighborhood of finish conveying path 81, third optional operation detection switch 84 which is an operation detection member for detecting the operation of sheets of paper P is arranged.

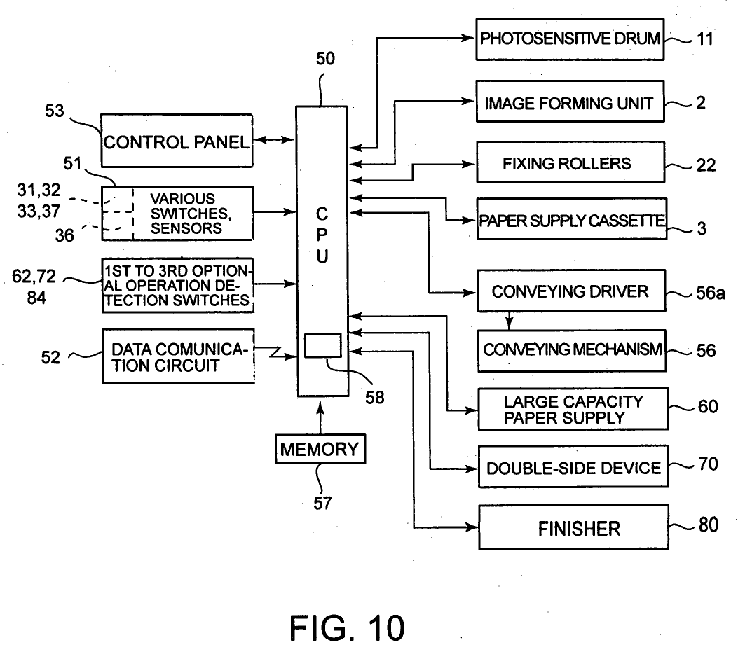

A block diagram of the control system of copier 10 including these optional functions is shown in FIG. 10. First to third optional operation detection switches 62, 72 and 84 are respectively connected to the input side of CPU 50. Large capacity paper supply device 60, double-side device 70 and finisher 80 are all connected to CPU 50 for controlling whole copier 10.

First to third optional operation detection switches 62, 72 and 84 respectively have the same construction as that of operation detection switch 36 of the first embodiment. First optional operation detection switch 62 recognizes the pattern of sheets of paper P passing paper supply conveying path 61 and calculates the conveying speed or acceleration of sheets of paper P by arithmetic unit 58 of CPU 50. First optional operation detection switch 62 compares the calculated conveying speed or acceleration with reference conveying speed V0 or reference acceleration of memory 57, immediately detects an occurrence of jamming of sheets of paper P during conveying on paper supply conveying path 61, and controls to stop large capacity paper supply device 60.

Second optional operation detection switch 72 recognizes the movement of sheets of paper P passing double-side conveying path 71 and calculates the conveying speed or acceleration of sheets of paper P by arithmetic unit 58 of CPU 50. Second optional operation detection switch 72 compares the calculated conveying speed or acceleration with reference conveying speed V0 or reference acceleration of memory 57, immediately detects an occurrence of jamming of sheets of paper P during conveying on double-side conveying path 71, and controls to stop double-side device 70.

Third optional operation detection switch 84 recognizes the movement of sheets of paper P passing finish conveying path 81 and calculates the conveying speed or acceleration of sheets of paper P by arithmetic unit 58 of CPU 50. Third optional operation detection switch 84 compares the calculated conveying speed or acceleration with reference conveying speed V0 or reference acceleration of memory 57, immediately detects an occurrence of jamming of sheets of paper P during conveying on finish conveying path 81, and controls to stop finish device 80.

In this embodiment having such a constitution, in large capacity paper supply device 60, double-side device 70, or finisher 80, independent first to third optional operation detection switches 62, 72 and 84 respectively recognize the conveying condition of sheets of paper P in paper supply conveying path 61, double-side conveying path 71, or finish conveying path 81, detect immediately an occurrence of jamming of sheets of paper P, and can stop conveying of sheets of paper P. Therefore, in the optional functions, the peripheral devices of the occurred jam can be prevented from damage due to delay of conveyance stop of sheets of paper P. Further, removal maintenance of sheets of paper P in the optional functions is facilitated.

Further, the present invention is not limited to the aforementioned embodiments and can be modified within a range which is not deviated from the object thereof, and for example, the position requiring detection of the conveying condition of sheets of paper is not limited to the arrangement position of the operation detection member, and the operation detection member may be arranged at a plurality of positions in the conveying path. Further, if the conveying condition of sheets can be detected overall the conveying path by the operation detection member, the passing detection member may not be used. Further, the operation detection switch 63 of the embodiments can detect the existence of sheets of paper. When sheets of paper do not exist in the part of the operation detection switch 36 or exist, operation detection switch 36 compares the light reception pattern or light reception amount of light reception unit 36c and detects the existence of sheets of paper. When jamming occurs in the apparatus, the existence position of sheets of paper can be displayed for the operator.

Further, the constitution of the image forming apparatus is not limited, and for example, a color image forming apparatus of a tandem type of arrangement of a plurality of image forming units along the transfer belt may be used, or a printer of an injection type may be used. Further, in an image forming apparatus for transferring a toner image formed on an image carrying member to sheets via an intermediate transfer medium, it is possible to arrange the operation detection member in the neighborhood of the conveying path of sheets passing the secondary transfer position of the intermediate transfer medium, detect the movement of sheets passing the conveying path, thereby immediately detect an occurrence of jamming.

As described above in detail, according to the present invention, the conveying condition of sheets during conveying is recognized by a single operation detection member, thus an occurrence of jamming of sheets is detected immediately, and the conveyance of sheets is stopped immediately, and the image forming process can be stopped. Therefore, regardless of an occurrence of jamming, the peripheral devices can be prevented from damage and soiling due to extension of jamming, and images of good quality can be obtained. Further, sheets can be removed easily and the maintainability can be improved.

What is claimed is:

1. A sheet conveying apparatus comprising:
a supply unit to supply sheets in a predetermined direction;
a conveying member to convey the sheets supplied by the supply unit in the predetermined direction on a conveying path;
a loading unit to load the sheets conveyed by the conveying member;
an operation detection member arranged in the neighborhood of the conveying path from the supply unit to the loading unit to independently detect an operation of the sheets on the conveying path; and
a controller to control conveyance of the sheets according to a detection result by the operation detection member.

2. The apparatus according to claim 1, wherein the operation detection member detects a speed of the sheets.

3. The apparatus according to claim 1, wherein the controller stops conveyance of the sheets on the basis of comparison of the detection result by the operation detection member with a reference value stored in a memory beforehand.

4. The apparatus according to claim 1, wherein the controller compares the detection result by the operation detection member with a reference value stored in a memory beforehand and stops conveyance of the sheets when a difference between the detection result and the reference value is larger than a specified value.

5. The apparatus according to claim 1, wherein the operation detection member has a light reception unit to detect a pattern of reflected light from the sheets.

6. The apparatus according to claim 1, wherein the operation detection member has a rotary member following an operation of the sheets and a following detection member to detect a speed of the rotary member.

7. An image forming apparatus comprising:
an image carrying member;
an image forming unit to form a toner image on the image carrying member;
a supply portion to supply a sheet toward the image carrying member;
a transfer unit to transfer the toner image on the image carrying member onto the sheet;
a fixing unit to fix the toner image on the sheet;
a loading unit to load the sheet after passing the fixing unit;
a conveying member to convey the sheet supplied by the supply unit toward the loading unit on a conveying path;
an operation detection member arranged in the neighborhood of the conveying path to independently detect an operation of the sheet on the conveying path; and
a controller to control conveyance of the sheet according to a detection result by the operation detection member.

8. The apparatus according to claim 7, wherein the operation detection member detects a speed of the sheet.

9. The apparatus according to claim 7, wherein the controller stops conveyance of the sheet on the basis of comparison of the detection result by the operation detection member with a reference value stored in a memory beforehand.

10. The apparatus according to claim 7, wherein the controller compares the detection result by the operation detection member with a reference value stored in a memory beforehand and stops conveyance of the sheet when a difference between the detection result and the reference value is larger than a specified value.

11. The apparatus according to claim 7, wherein the operation detection member has a light reception unit to detect a pattern of reflected light from the sheet.

12. The apparatus according to claim 7, wherein the operation detection member has a rotary member following an operation of the sheet and a following detection member to detect a speed of the rotary member.

13. The apparatus according to claim 7, wherein the operation detection member is provided in the neighborhood of the conveying path between the transfer unit and the fixing unit.

14. The apparatus according to claim 7, wherein the supply portion further includes a first optional conveying path and the operation detection member is arranged in the neighborhood of the first optional conveying path.

15. The apparatus according to claim 7, wherein the supply portion further includes a second optional conveying path between the fixing unit and the loading unit and the operation detection member is arranged in the neighborhood of the second optional conveying path.

16. A sheet conveying method comprising:
conveying sheets supplied by a supply portion in a predetermined direction on a conveying path;
detecting an operation of the sheets during conveying the sheets by an independent operation detection member; and
controlling the conveyance of the sheets according to a detection result by the detecting.

17. The method according to claim 16, wherein the detecting detects a speed of the sheets.

18. The method according to claim 16, wherein the detecting detects a pattern of reflected light from the sheets.

19. The method according to claim 16, wherein the detection detects a speed of a rotary member following an operation of the sheets.

20. The method according to claim 16, wherein the controlling stops conveyance of the sheets on the basis of comparison of a detection result by the detection with a reference value stored in a memory beforehand.
